(19) United States
(12) Patent Application Publication
(10) Pub. No.: US 2002/0046113 A1
(43) Pub. Date: Apr. 18, 2002

(54) Method and system of using an electronic network to provide options to purchase goods or services through a retailer

(76) Inventors: Daniel J. Pisano JR., Ridgefield, CT (US); Robert B. Trumbull, Ridgefield, CT (US)

Correspondence Address: Charles N.J. Ruggiero, Esq., Ohlandt, Greeley, Ruggiero & Perle, L.L.P., 10th Floor, One Landmark Square, Stamford, CT, 06901-2682, US

(21) Appl. No.: 09/921,117

(22) Filed: Aug. 2, 2001

Related U.S. Application Data
(60) Provisional application No. 60/223,220, filed on Aug. 4, 2000.

(51) Int. Cl. G06F 17/60

(52) U.S. Cl. 705/14

(57) ABSTRACT

A system that provides consumers with a shopping incentive that includes an option to purchase a good/service at a fixed price. The system interacts with a consumer using a consumer terminal and a store via the Internet or World Wide Web. The system presents a web page to the consumer terminal containing the options. Consumer selections of options and preferred store purchase are sent to such store with the consumer's identity. The store sends the system the details of purchase transactions using the selected options including then prevailing prices. This information may be used to determine a reimbursement for the store. A correlation is developed between a plurality of options offered and actual transactions using options selected. The correlation is used to determine options to be offered in the future.

### RELATED APPLICATION

This application claims the benefit of U.S. Provisional Patent Application, Serial No. 60/223,220, filed Aug. 4, 2000.

### BACKGROUND OF THE INVENTION

1. Field of the Invention

This invention relates to a method and system that provides a shopper with a fixed price for a good or service prior to visiting a store of his or her choice.

2. Description of the Prior Art

A store, for example a retail store, needs the flexibility to set and adjust prices. The business premise underlying pricing adjustments for a retail store is to create traffic within the retail store and to increase the flow of goods through the store. Doing so increases the inventory turns of the retail store and improves cash flow. Making pricing adjustments within the store has impact limited to shoppers within the store. Using conventional media, such as print and radio/TV, to make pricing adjustments broadly known outside the store requires quite a long lead time, usually on the order of several weeks. Consequently, the time between deciding to make the pricing adjustment and seeing the effect on a particular store's inventory is quite long. Because of the uncertainty involved so far in the future, there is a danger of being out of stock in a specific store on the item being sold, leading to customer disappointment, or being overstocked, resulting in cash being tied up. The ability to initiate and change pricing quickly is a big advantage to the retail store.

Conventional means of announcing price adjustments, such as newspapers, frequently cover the shopping area of several stores, making control of flow of goods and consequent inventory levels in a particular store impractical. Using an electronic network to make rapid pricing adjustments which are specific to an individual in the trading area of a specific store, largely eliminates the limitations of previous pricing adjustment and announcement methods. Computer networks provide the opportunity to rapidly change prices and to effect these changes at very low cost in a very focused way. This capability will increasingly be used to make rapid changes in prices. In an environment of frequent price changes, consumers will increasingly benefit from the ability to secure an attractive price that may not be available at a future time. Store operators benefit from the ability to control the flow of goods and inventory levels at a remote retail establishment. It is important that a specific retail establishment be identified and options for purchase be determined that are specific to an individual store and consumer.

A system that uses a computer network to provide shopping help and incentives to a customer is described in U.S. Pat. No. 6,014,634. This system provides a customer with ads and incentives as well as a capability of generating a shopping list of items from a terminal. The shopping list is then filled by a selected retailer for pick-up by or delivery to the customer. The incentives include discounts from a current price. Another system that uses a computer network to distribute price discounts in the form of an electronic coupon is described in U.S. Pat. No. 5,761,648.

Other systems that use a computer network to provide a customer with shopping help permit the immediate purchase of an item at a current defined or list price or at a price determined by an on-line auction. None of these systems give the shopper the ability to secure an attractive price for a good or service to be purchased immediately or in the future.

The right to purchase an item in the future at a set price is known as an option. For example, options are currently offered for various financial products. However, the inventors are unaware that options have been offered to customers for the purchase of goods or services from a retail store.

### SUMMARY OF THE INVENTION

An object of the present invention is to provide retail customers with options to secure fixed prices for the purchase of goods or services.

Another object of the present invention is to provide a method and system that optimizes option prices for goods and services based on cash flow, inventory flow, manufacturing flow, business goals and priorities of retailers and manufacturers.

These and other objects are achieved by the present invention in a method and system that provides a consumer with a shopping incentive that includes an option to purchase a good/service at a fixed price. The invention determines a plurality of fixed price options to purchase goods/services offered by a plurality of stores. The options are offered either by the stores or by suppliers of the goods/services, such as manufacturers. The options are presented via a web page to a terminal used by a consumer. The identity of a consumer using the terminal is established. Information, namely, the consumer identity, an option and a store for exercise thereof selected by the consumer, is sent to the selected store.

According to one embodiment of the present invention, a reimbursement to the store is determined from a comparison of the option price with the price prevailing at the time of the purchase transaction in which the option is used. According to another embodiment of the present invention, a correlation between the options and their purchase transactions is employed to determine additional options to be offered in the future. According to another embodiment of the present invention, the price of an option is determined based on inventory data for the good/service of the option and/or other data that includes consumer past purchase history, shopping history, individual characteristics or other data. The other data may include weather, store location and the like.

### BRIEF DESCRIPTION OF THE DRAWINGS

Other and further objects, advantages and features of the present invention will be understood by reference to the following specification in conjunction with the accompanying drawings, in which like reference characters denote like elements of structure and:

FIG. 1 is a block diagram of a computer network that includes the system of the present invention;

FIG. 2 is a block diagram of the ad server depicted in the system of FIG. 1; and

FIG. 3 is a flow diagram of the option program of the ad server of FIG. 2.

### DESCRIPTION OF THE INVENTION

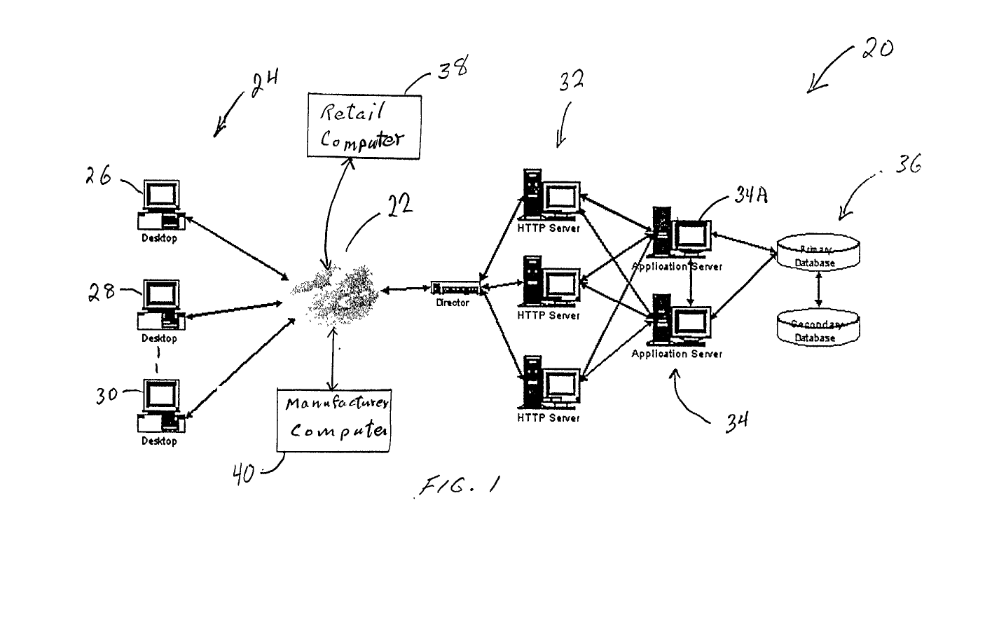

Referring to FIG. 1, a computer network system generally represented by reference numeral 20 serves web pages via the Internet 22 to one or more retail customer terminals 24. Each retail customer terminal 24 may have a desktop terminal as shown or any other type of terminal that has a browser capability. Although only three customer terminals 26, 28 and 30 are shown, it will be appreciated by those skilled in the art that the number of customer terminals is limited only by the capacity of the internet and the worldwide web. The dashed line from customer terminal 28 to a customer terminal 30 illustrates this capacity.

Computer network system 20 includes one or more HTTP servers 32, one or more application servers 34 and a database 36. HTTP servers 32 may be any suitable servers, presently known or developed in the future, that are capable of communicating via internet 22 with retail customer terminals 24 in a protocol that is compatible with the browser capability of terminals 24. Application servers 34 may be any suitable servers, presently known or developed in the future, that are capable of running applications that supply web page data to HTTP servers 32 and interact with web page actions taken at retail customer terminals 24. Database 36 may be any suitable database, presently known or developed in the future, that is capable handling of large amounts of data.

Application servers 34 of computer network system 20 communicate with a retail computer 38 of a retail store and with a manufacturer computer 40 of a manufacturer via Internet 22. Alternatively, retail computer 38 and manufacturer computer 40 may communicate with application servers 34 via an alternative communication link, such as a public telephone network or the like. Retail computer 38 typically processes point of sale transactions, inventory flow, cash flow and other business data. Manufacturer computer 40 typically processes manufacturing orders and flow, shipments, inventory, cash flow and other business data. Although only a single retail computer 38 and a single manufacturer computer 40 are shown, it will be appreciated by those skilled in the art there may be one or more such computers for each retail organization or manufacturer that participates in the retail option service offered by the system and method of the present invention.

According to the present invention, at least one of the application servers, designated as 34A in FIG. 1, is programmed to serve web pages that contain advertisements and options to purchase goods/services at fixed prices. The invention couples electronic pricing adjustment, through the offering of options to purchase at adjusted prices, with a procedure for predicting inventory flow in a specific retail store at some future time, taking into account the impact of alternative pricing levels and structures. The options may be offered either by the retailer or by a manufacturer or other supplier of the goods. This allows the retail store or manufacturer to optimize pricing with respect to inventory and cash flow with alternative pricing schemes, which can be adjusted rapidly and focused very specifically. These pricing schemes offer specific items for sale at specific prices. In some cases, the savings available to the customer of the offered price compared to a normal prevailing price or current on-shelf price may be disclosed.

In order to predict traffic and inventory flow, it is necessary to know the effect of many parameters on consumers' buying habits. The procedure of the present invention is to determine the correlation of various pricing schemes by building an experience base using test pricing and recording actual product movement at various time intervals along with any other parameters, which the retailer and the manufacturer deem relevant. These may be day of the week, weather in the store area, date in relation to major holidays, length of time pricing runs, etc. Recording of buying patterns may also be desirable, e.g. noting what other goods the consumer purchases along with the specially priced item. This data is recorded in an initial training database.

At this point, an initial guess is made of the correlation between these events and the pricing. This correlation takes the form of an equation with unknown weight factors. For example,

I(t)=F(X,W)

where

X=(X1, . . . , Xn)= input vector of the above referenced variables

W= Matrix of weights which operate on the input vector and transform it through each hidden layer of the neural network. Note that there can be one or more hidden layers in the network.

The coefficients in this equation are then determined using standard neural network training procedures. This training results in a first approximation at inventory flow as a function of price level, change in price versus prevailing prices, time, and the other parameters that were deemed relevant above.

It is then possible to select a price and make a prediction of inventory flow as a function of the other parameters. Additional data may then be collected when a subsequent price is offered for insertion into the existing experience database and the above equation “retrained” to improve the accuracy of the predictions. In this manner, pricing selections may be optimized against desired inventory levels.

While in-store price changes can, in some cases, be adjusted rapidly, such changes have very limited reach, affecting only shoppers currently in the store. Special pricing offers of all kinds that are distributed via conventional media, such as newspapers and direct mailings, have long lead times (normally several weeks) for execution. Hence, a large uncertainty is built into the prediction, as there is no traceability between the price offer and its utilization. Furthermore, if the pricing scheme results in too rapid a consumption, there is a danger of running out of stock on the item, leading to customer dissatisfaction and an additional retailer costs associated with servicing this customer. On the other side, the conventional distribution of pricing offers results in too little response. Then, there is excess stock at the retailer that must be dealt with.

Because of the long lead times for conventional distribution of pricing announcements, there is no probability that the pricing scheme can be modified or terminated in a timely fashion. Distribution of pricing offers via an electronic network, such as the World Wide Web, provides an opportunity to modify pricing schemes in a timely manner, and hence influence inventory and flow of retailer goods.

Thus, the present invention permits the consumer to be offered options reflecting advantageous pricing online for specific products. These prices will be available to him when he makes his purchase in a selected store during a selected period. An important feature of the invention is the capture of specific retail store selection, or most frequent shopping area, for the consumer. This allows optimization of pricing against turnover or inventory objectives for specific retail outlets from the electronic network. Provision is made for the offering to include the regular or prevailing price along with the specially offered price, so the consumer can judge the value of the offering. The offering of the option reflecting the special price may be made online (an Internet site on the World Wide Web) or through an in-store kiosk.

It may also be desirable for the consumer to secure or lock in prices for all items on his shopping list regardless of whether they are offered at a special price or at the regular price of the store. This feature of the invention will enable the consumer to know in advance of visiting the store the maximum he will pay for his purchases.

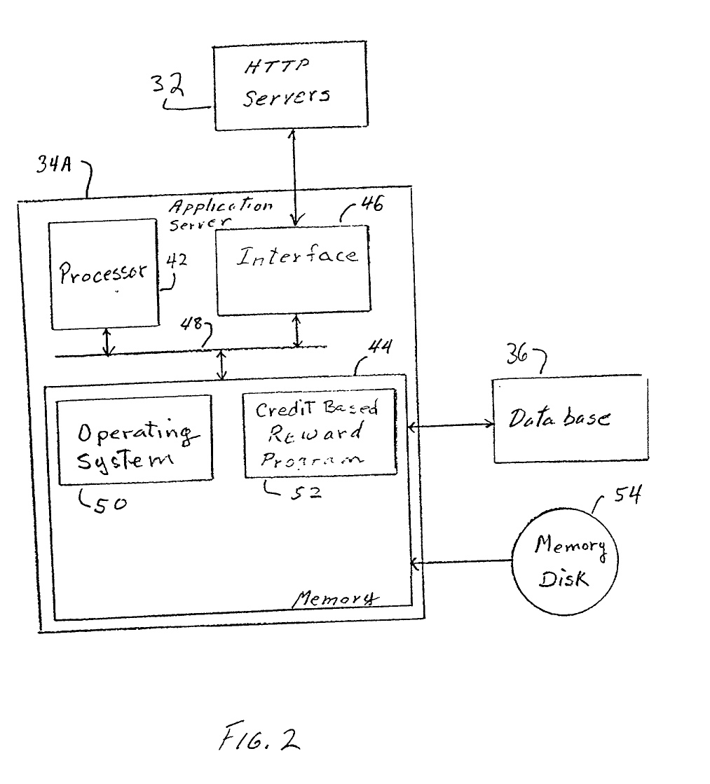

Referring to FIG. 2, ad server 34A includes a processor 42, a memory 44 and an interface 46 that are interconnected via a computer bus 48. Stored in memory 44 are an operating system 50 and an options program 52. Although operating system 50 and options program 52 are shown as stored in memory 44, it will be appreciated by those skilled in the art that these programs, as well as others, may be loaded into memory 44 from a memory media, shown as a memory disk 54.

It will apparent to those skilled in the art that options program 52 may alternatively be distributed among ad server 34A and the other application servers 34, database 36 or other computers. The physical locations of HTTP servers 32, application servers 34 or database 36 are unimportant to the present invention. They may be in the same physical location or in separate locations that communicate via Internet 22 or other communication facility.

Processor 42 under the direction of operating system 50 and options program 52 provides web page data via interface 46 to HTTP servers 32 and interacts with actions taken on the web pages by customer terminals 24. Options program 52 establishes option prices for goods or services offered by participating retailers or supplied by participating manufacturers based on business data supplied by such retailers and manufacturers, and offers these options to retail customer terminals 24. The records and business data for these options may be stored in database 36.

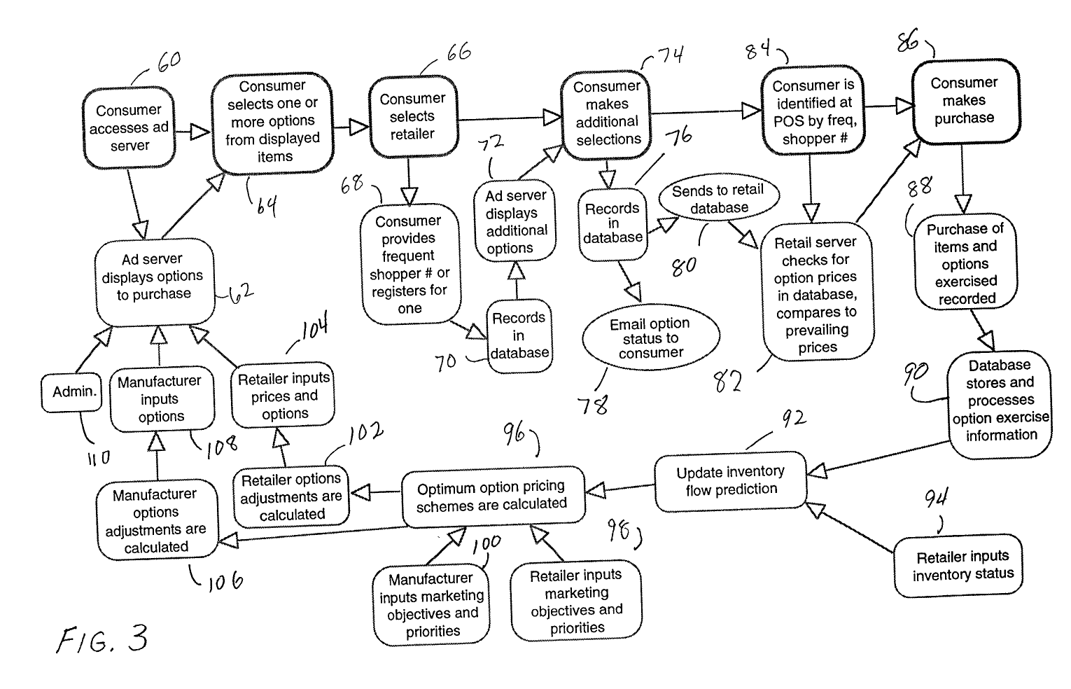

Referring to FIG. 3, the method of the present invention is initiated at step 60 when customer terminal 26, for example, accesses ad server 34A. Step 62 causes ad server 34A to serve a web page to customer terminal 26 that presents a plurality of options for selection by the customer. At step 64, the customer selects one or more of the options. At step 66, the customer identifies a retailer where the selected goods or services of the selected options will be purchased. At step 68, the customer provides a shopper identification. The selected options and retailer and shopper identification are communicated to ad server 34A by standard browser and Internet protocol and techniques.

Step 70 causes ad server 34A to store the selected options and retailer and shopper identification in database 36. Step 72 presents additional options to customer terminal 26. At step 74, the customer makes additional selections, which are recorded in database 36 by step 76. Step 78 communicates the selected option status to the customer, as by email or posting on a web page. Step 80 sends the selected options and retailer and shopper identification to retail computer 38 of the selected retailer.

At step 84, the selected retailer verifies the customer's identity at a point of sale. It will be appreciated that the point of sale may be a point of sale transaction terminal in a physical retail store or a virtual point of sale established via internet 22 between customer terminal 26 and retail computer 38. Step 82 verifies the customer's identity and the option prices and compares the option prices to the then prevailing prices. Step 86 completes the transaction between the customer and the retailer for the good/services of the selected options. Step 88 records the transaction data in retail computer 38. Step 90 processes and stores the transaction data in a database (not shown) that is associated with retail computer 38 and/or send such data to ad server 34A.

At step 94, the retailer sends its inventory status for the goods/services of the just exercised option as well as other options registered with ad server 34A. At step 92, options program 52 updates an inventory flow prediction of the goods/services of the option data received from the retailer. At step 96, options program 52 determines optimum pricing schemes for the good/services of the retailer, based on the inventory flow prediction and other data inputted by the retailer by step 98. This data includes marketing objectives and priorities of the retailer, for example. Options program 52 also determines at step 96 optimum pricing schemes for the good/services of the manufacturer based on data inputted by the manufacturer by step 100. This data includes, for example, marketing objectives and priorities.

At step 102, the optimum option prices are made available to the retailer for its review and adjustments. At step 104, options program 52 receives and stores the options and price adjustments approved by the retailer. At step 106, the optimum option prices are made available to the manufacturer for its review and adjustments. At step 108, options program 52 receives and stores the options and price adjustments approved by the manufacturer.

Step 62 then presents the approved options offered by a manufacturer of goods and/or the approved options offered by selected retail stores to customer terminals 24 that access ad server 62. Step 110 performs administrative functions of ad server 34A.

In conjunction with and/or separately from pricing optimization determinations described above, specific marketing goals for efficiently gaining market share or volume may be served by determining pricing schemes for the options based on factors related to customer information, including:

customer supplied descriptive information and preferences including demographic information,

normal or most frequent shopping area and/or stores,

previous purchase history, including products and brands selected,

previous shopping history among different retail establishments,

other option to purchase offers selected, and

retail stores selected.

Information related to each of these factors, identifiable on a consumer specific basis, is stored in databases. Participating manufacturers and retailers provide marketing priorities for defined periods of time. Specific determination of pricing schemes for options to purchase to be offered is done by optimizing the projected impact of alternative factors against the marketing priorities provided based on historical or estimated utilization of the options offered, and/or through utilization of linear programming or other mathematical optimization tools.

When the consumer visits a selected store in the above site activity and makes purchases using a frequent shopper card or other identifying card, the store's point-of-sale system searches the store's server using the consumer's number to ascertain if an item is one that the consumer had previously chosen from a visit to the site of ad server 34A at a special price. If so, that special price is compared with the prevailing price and the lower price is chosen. If the special price is lower than the prevailing price, that difference along with the item identification is noted in a special database on the store's server. If the prevailing price is lower than the special price, no action is taken.

Regularly, the store's server sends to ad server 34A information identifying items that were purchased at special prices and the difference in the prevailing price and the special price. Optionally, the consumer's identifying number may also be transmitted. This item and price difference information is used to determine what reimbursements the store may be entitled to according to some previously agreed upon formula. A similar path is followed for items that are purchased under the optional, guaranteed pricing offering.

The data from the store's server is collected over time to create a database of information regarding pricing levels and structures. A neural network is trained using this data, so that a correlation between a price offering and a purchase is generated. Using this neural network, it is possible to predict the amount of inventory required to support a given price offering. Alternately, it is possible to predict the optimum pricing consistent with a desired flow of goods and inventory level.

The present invention having been thus described with particular reference to the preferred forms thereof, it will be obvious that various changes and modifications may be made therein without departing from the spirit and scope of the present invention as defined in the appended claims.

What is claimed is:

1. A method of providing a consumer with a shopping incentive comprising:
(a) determining a plurality of fixed price options to purchase goods/services offered by a plurality of stores;
(b) presenting a web page to a terminal used by said consumer wherein the web page contains one or more of said plurality of options;
(c) establishing an identity of said consumer; and
(d) presenting said selected option and said consumer identity to said selected store in response to said consumer selecting, via said terminal, one of said plurality of options and one of said plurality of stores.

2. The method of claim 1, further comprising (e) adjusting the fixed price of one of said plurality of options if requested by one of said plurality of stores that offers said one option whose price is being adjusted.

3. The method of claim 1, wherein step (a) determines the fixed prices of said plurality of options from inventory data of said plurality of stores and other data deemed relevant by said plurality of stores.

4. The method of claim 3, wherein said other data includes information concerning previously selected options of said consumer.

5. The method of claim 4, wherein said other data includes stores where said consumer has previously purchased goods/services.

6. The method of claim 3, wherein said other data includes marketing goals of said plurality of stores.

7. The method of claim 1, further comprising (f) determining a reimbursement to said selected store in response to receipt from said selected store of information identifying an exercise of said selected option by said consumer including the option price and a then prevailing price.

8. The method of claim 1, wherein at least one of said plurality of options is offered by a supplier of said goods/services.

9. The method of claim 8, wherein said supplier is a manufacturer of one of said goods/services.

10. The method of claim 1, further comprising (g) establishing a correlation between said plurality of options and one or more purchase transactions that use said plurality of options, and wherein step (a) determines additional options based on said correlation.

11. A system that provides a consumer with a shopping incentive, said system comprising:
an application server that presents web pages to a consumer via the Internet;
wherein said application server includes a program that performs the steps of:
(a) determining a plurality of fixed price options to purchase goods/services offered by a plurality of stores;
(b) presenting a web page to a terminal used by said consumer, wherein the web page contains one or more of said plurality of options;
(c) establishing an identity of said consumer; and
(d) presenting said selected option and said consumer identity to said selected store in response to said consumer selecting, via said terminal, one of said plurality of options and one of said plurality of stores.

12. The system of claim 12, wherein said program further comprises the step of (e) determining a reimbursement to said selected store in response to receipt from said selected store of information identifying an exercise of said selected option by said consumer including the option price and a then prevailing price.

13. The system of claim 11, wherein said program further comprises the step of (f) establishing a correlation between said plurality of options and purchase transactions that use said plurality of options, and wherein step (a) determines additional options based on said correlation.

14. The system of claim 11, wherein step (a) determines the fixed prices of said plurality of options from inventory data of said plurality of stores and other data deemed relevant by said plurality of stores.

15. The system of claim 14, wherein said other data includes information concerning previously selected options of said consumer.

16. The system of claim 15, wherein said other data includes stores where said consumer has previously purchased goods/services.

17. The system of claim 14, wherein said other data includes marketing goals of said plurality of stores.

18. The system of claim 11, wherein at least one of said plurality of options is offered by a supplier of said goods/services.

19. The system of claim 18, wherein said supplier is a manufacturer of one of said goods/services.

20. A computer readable medium that includes executable instructions for performing the steps that comprise:
(a) determining a plurality of fixed price options to purchase goods/services offered by a plurality of stores;
(b) presenting a web page to a terminal used by said consumer wherein the web page contains one or more of said plurality of options;
(c) establishing an identity of said consumer; and
(d) presenting said selected option and said consumer identity to said selected store in response to said consumer selecting, via said terminal, one of said plurality of options and one of said plurality of stores.
